(19) United States
(12) Patent Application Publication
(10) Pub. No.: US 2025/0304145 A1
(43) Pub. Date: Oct. 2, 2025

(54) STEERING DEVICE

(71) Applicant: TOYODA GOSEI CO., LTD., Kiyosu-shi, Aichi-ken (JP)

(72) Inventor: Rie ONO, Kiyosu-shi (JP)

(21) Appl. No.: 19/027,943

(22) Filed: Jan. 17, 2025

(30) Foreign Application Priority Data
Mar. 26, 2024 (JP) 2024-050380

(51) Int. Cl. B62D 1/06

(52) U.S. Cl. CPC B62D 1/065

(57) ABSTRACT

A steering device mounted on a vehicle including:
a grip portion gripped by a driver during steering;
a heating element that is provided inside the grip portion and generates heat by energization, the heating element including carbon nanotubes supported on a knit formed by knitting fibers; and
an electrode portion configured to energize the heating element.

### CROSS-REFERENCE TO RELATED APPLICATIONS

The present application claims priority from Japanese Patent Application No. 2024-050380 of Ono, filed on Mar. 26, 2024, the disclosures of which are hereby incorporated into the present application by reference.

### BACKGROUND

### Technical Field

The present invention relates to a steering device including a heating element inside a grip portion that is gripped by a driver.

### Description of Related Art

As a conventional measure against coldness in winter, as disclosed in JP 2018-002101 A, a configuration is known in which a heating element that generates heat by energization is provided inside a grip portion, gripped by a driver, in a steering wheel as a steering device. The heating element disclosed in JP 2018-002101 A includes a metal heater wire provided on a resin base material.

Carbon nanotubes are lightweight materials with excellent electrical and thermal conductivity and far-infrared radiation heat effects, and therefore, a configuration using carbon nanotubes as a heating element instead of metal is conceivable. However, carbon nanotubes are hard materials. Thus, in a case where carbon nanotubes are simply supported uniformly on a base material and assembled onto the grip portion, deterioration in the ease of assembly of the heating element may occur, such as cracking of carbon nanotubes when the base material is bent to conform to the curved surface of the grip portion.

### SUMMARY

An object of the present invention is to provide a steering device capable of suppressing deterioration in the ease of assembly of a heating element while using carbon nanotubes as the heating element.

A typical configuration of the steering device according to the present invention is as follows:

A steering device mounted on a vehicle including: a grip portion gripped by a driver during steering; a heating element that is provided inside the grip portion and generates heat by energization, the heating element including carbon nanotubes supported on a knit formed by knitting fibers; and an electrode portion configured to energize the heating element.

### BRIEF DESCRIPTION OF THE DRAWINGS

FIG. 1 is a view of the surroundings of a driver's seat in a vehicle equipped with a steering wheel, as viewed from the left side.

FIG. 2 is a front view of the steering wheel.

FIG. 3 is a cross-sectional view of the grip portion of the steering wheel.

FIG. 4 is a perspective view of a knit body of the grip portion.

FIG. 5 is a developed view of the knit body developed in a flattened state.

FIGS. 6A and 6B are a cross-sectional view and an enlarged view of the knit body.

FIG. 7 is a schematic view illustrating a state of the knit body when assembled onto the grip portion.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

Hereinafter, a steering device according to an embodiment of the present invention will be described with reference to the drawings. Note that the dimensions, materials, shapes, relative arrangements, and the like of components described below are not intended to limit the scope of the present invention, unless otherwise specified.

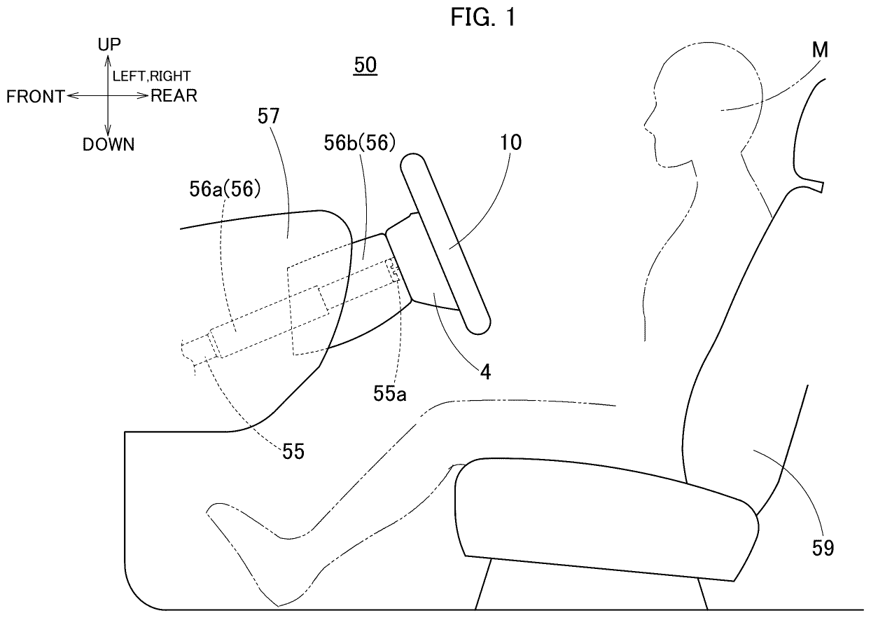

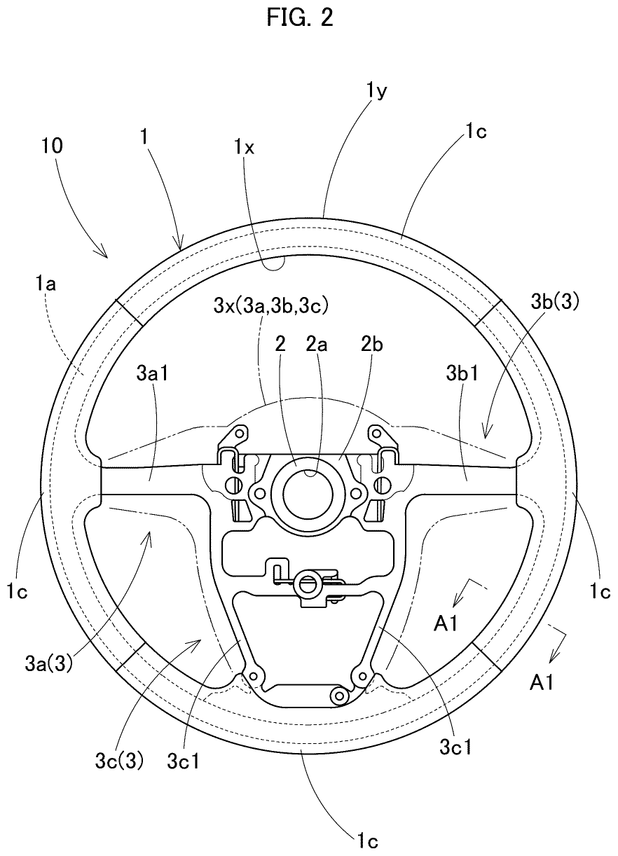

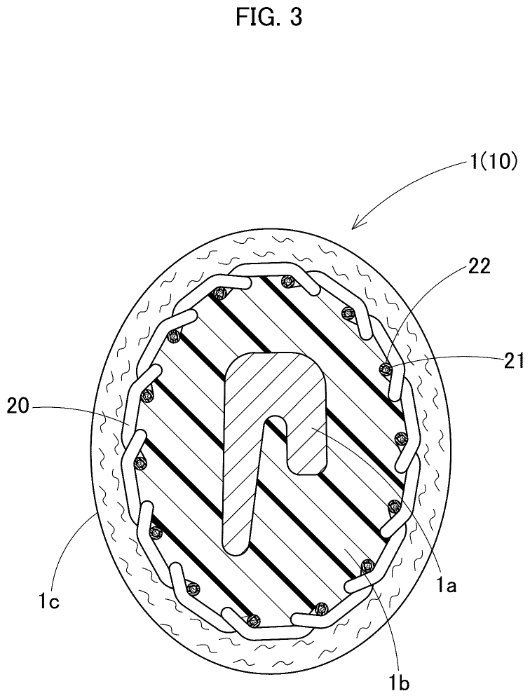

FIG. 1 is a view of the surroundings of a driver's seat 59 in a vehicle 50 equipped with a steering wheel 10 as a steering device, as viewed from the left side, with a driver M seated on the driver's seat 59 indicated by a two-dot dash line. FIG. 2 is a front view of the steering wheel 10, with an upper cover 3x made transparent to facilitate viewing of the internal configuration, and with only the outline indicated by two-dot dash lines. FIG. 3 is a cross-sectional view of a grip portion 1 of the steering wheel 10 taken along line A1-A1 in FIG. 2.

In the following description, unless otherwise specified, each direction described with respect to the steering wheel 10 means a direction in a state where the steering wheel 10 is mounted on the vehicle 50 illustrated in FIG. 1. That is, the left-right direction means the left direction and the right direction of the vehicle 50 equipped with the steering wheel 10, specifically, the left direction and the right direction as viewed from the driver M. The front-rear direction substantially coincides with the front direction and the rear direction of the vehicle 50, specifically, the front direction and the rear direction as viewed from the driver M. The up-down direction substantially coincides with the vertically upward direction and the vertically downward direction.

As illustrated in FIG. 1, the steering wheel 10 is mounted on the vehicle 50 by being coupled to a steering shaft 55 of the vehicle 50. In the present embodiment, the vehicle 50 is an automobile. The vehicle 50 includes a steering column 56 including a column tube 56a that partially covers the outer periphery of the steering shaft 55 to support the steering shaft 55, and a column cover 56b that covers a portion of the steering shaft 55 protruding rearward from an instrument panel 57. The steering wheel 10 is attached to a rear end 55a of the steering shaft 55 protruding rearward from the instrument panel 57.

As illustrated in FIGS. 2 and 3, the steering wheel 10 includes a grip portion 1 gripped by the driver M when the vehicle 50 is steered, a hub portion 2 disposed inside the grip portion 1 and coupled to the steering shaft 55, and a spoke portion 3 that couples the grip portion 1 and the hub portion 2. A lower cover 4 is provided on the front side of the steering wheel 10 (cf. FIG. 1).

The grip portion 1 is a portion also referred to as a rim portion, and has an annular shape in the present embodiment, but may have another shape. The driver grips the grip portion 1 and rotationally steers the grip portion 1 around the steering shaft 55 to change the travel direction of the vehicle 50.

The grip portion 1 is formed by laminating a coating layer 1b, made of a material with cushioning properties such as foamed polyurethane, and a skin layer 1c, which is disposed on the outermost surface of the grip portion 1, onto a metal core material 1a made of aluminum alloy or similar material. A knit body 20, supporting carbon nanotubes 22 as a heating element that generates heat by energization, is provided between the coating layer 1b and the skin layer 1c. That is, the knit body 20 is provided inside the grip portion 1.

The skin layer 1c is divided into four sections in the rotational direction of the grip portion 1 and then bonded to the outer periphery of the knit body 20 with an adhesive. The skin layer 1c is formed of insulating leather, resin, or the like, and protects the driver M who grips the grip portion 1 from a current when the carbon nanotubes 22 are energized. A detailed configuration of the knit body 20 will be described later.

The hub portion 2 is a metal member coupled to the steering shaft 55, and includes a shaft hole 2a through which the steering shaft 55 is inserted. The hub portion 2 and the steering shaft 55 are coupled by fastening the rear end 55a of the steering shaft 55 with a nut while the rear end 55a is inserted through the shaft hole 2a and fitted thereto. The hub portion 2 is integrally molded with a metal core material 2b.

The spoke portion 3 includes a left spoke portion 3a and a right spoke portion 3b extending from the hub portion 2 to the left and right, respectively, and a lower spoke portion 3c extending downward. The left spoke portion 3a and the right spoke portion 3b include metal core materials 3a1, 3b1 extending left and right, respectively, to connect the core material 1a of the grip portion 1 and the core material 2b of the hub portion 2. The lower spoke portion 3c includes a metal core material 3cl extending downward from the core material 2b of the hub portion 2 and connected to the core material 1a of the grip portion 1 while branching to the left and right. The left spoke portion 3a, the right spoke portion 3b, and the lower spoke portion 3c include a resin upper cover 3x covering the core materials 3a1, 3b1, 3c1.

Here, the core material 1a of the grip portion 1, the core material 2b of the hub portion 2, and the core materials 3a1, 3b1, 3cl of the spoke portion 3 are integrally molded by die casting, whereby the grip portion 1, the hub portion 2, and the spoke portion 3 are coupled. However, the core material 1a of the grip portion 1, the core material 2b of the hub portion 2, and the core materials 3a1, 3b1, 3cl of the spoke portion 3 may be separately formed and coupled by welding or the like.

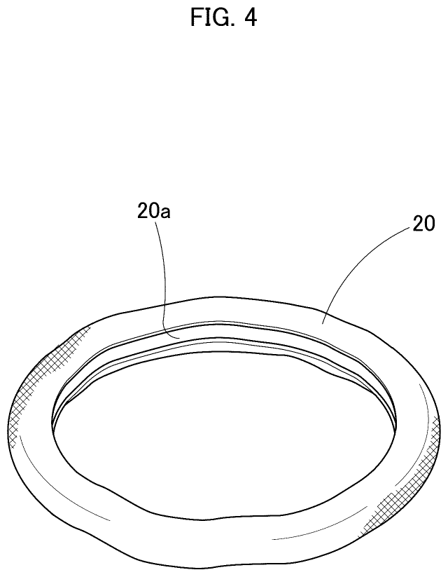

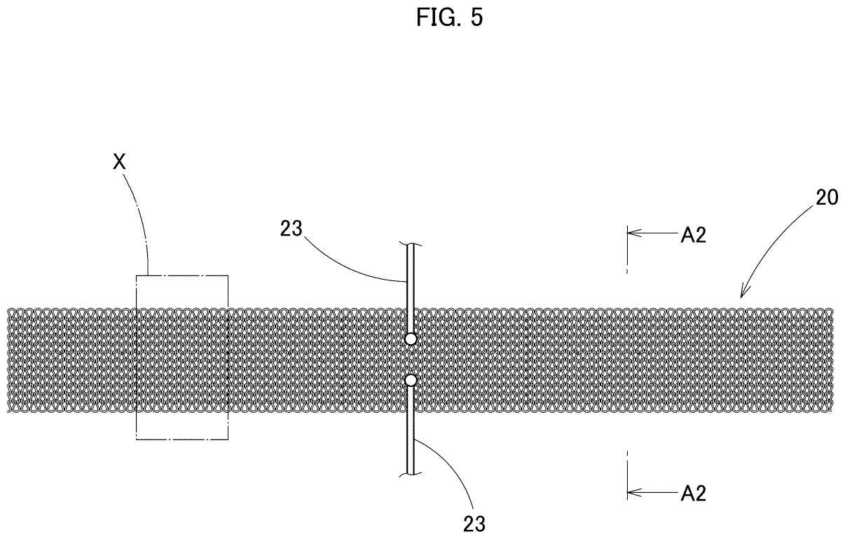

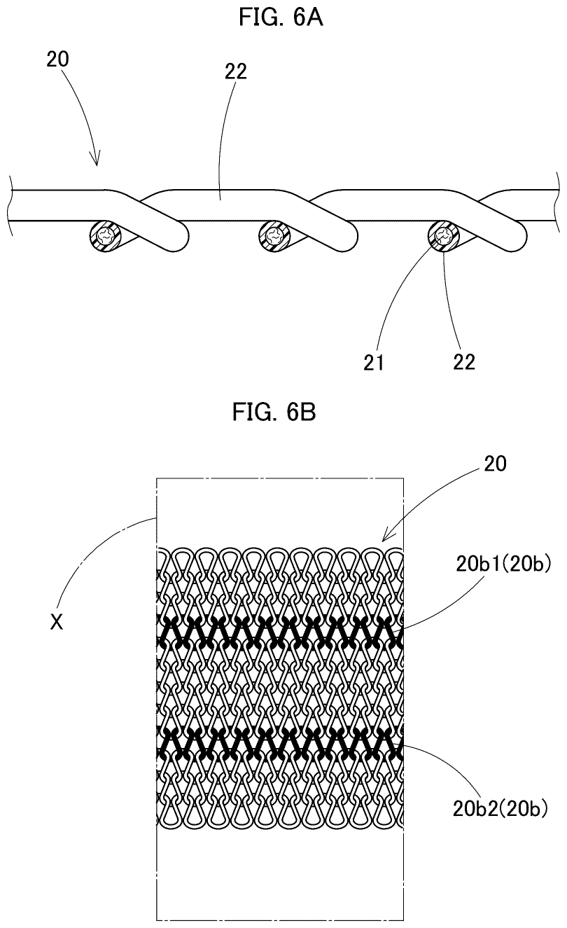

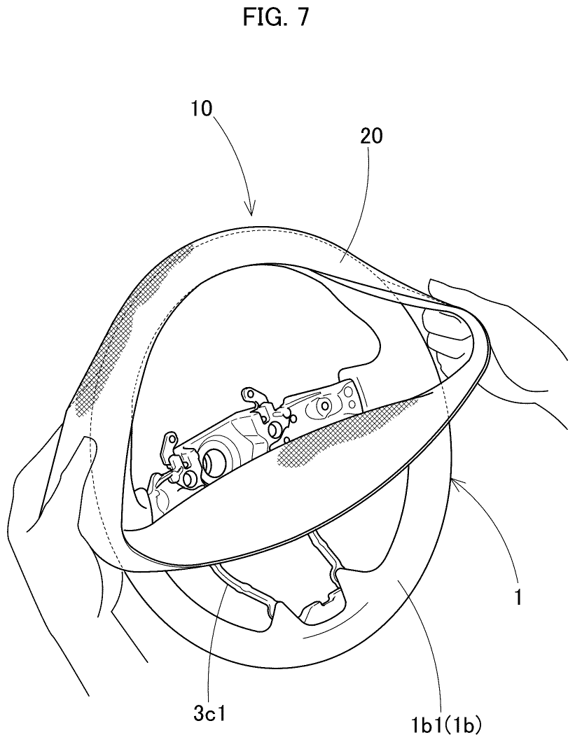

Next, a detailed configuration of the knit body 20 will be described. FIG. 4 is a perspective view of the knit body 20. FIG. 5 is a developed view of the knit body 20 developed in a flattened state. FIG. 6A is a cross-sectional view of the knit body 20 taken along line A2-A2 in FIG. 5. FIG. 6B is an enlarged view of a region X of the knit body 20 illustrated in FIG. 5. FIG. 7 is a schematic view illustrating a state of the knit body 20 when assembled onto the grip portion 1.

As illustrated in FIGS. 4, 5, 6A, 6B, and 7, the knit body 20 is an annular member formed by circular knitting (weft knitting) of stretchable fibers 21, such as urethane-based resin or elastomer. An opening 20a is formed on the inner periphery of the knit body 20. The opening 20a is formed over the entire circumference of the annular knit body 20. When the knit body 20 is assembled onto the grip portion 1, the core material 1a and the coating layer 1b of the grip portion 1 are accommodated inside the opening 20a. In other words, the knit body 20 is a bag-shaped member including the opening 20a as a bag mouth, and is assembled onto the grip portion 1 by covering the core material 1a and the coating layer 1b such that the core material 1a and the coating layer 1b are accommodated inside the bag.

The knit body 20 is also impregnated with the carbon nanotubes 22. Specifically, the knit body 20 is immersed in a dispersion liquid in which the carbon nanotubes 22 are dispersed, and a material such as a stretchable urethane-based resin or elastomer is contained, whereby the knit body 20 is impregnated with the carbon nanotubes 22. In this manner, the knit body 20 supports the carbon nanotubes 22. Note that the method for supporting the carbon nanotubes 22 on the knit body 20 is not limited thereto. For example, a method of applying the dispersion liquid to the knit body 20, or a method of thermally transferring or silk-printing the dispersion liquid, which has been made into ink, onto the knit body 20, may be adopted.

A conductive yarn is included in a part of the fibers 21 forming the knit body 20, and the conductive yarn constitutes an electrode portion 20b for energizing the carbon nanotubes 22. An anode 20b1 of the electrode portion 20b is disposed on an inner periphery 1x (FIG. 2) side of the grip portion 1 over the entire region in the rotational direction of the grip portion 1. A cathode 20b2 of the electrode portion 20b is disposed on the outer periphery (FIG. 2) side of the grip portion 1 over the entire region in the rotational direction of the grip portion 1. That is, the anode 20b1 and the cathode 20b2 of the electrode portion 20b are arranged alongside each other in the circumferential direction of the grip portion 1 in a state where the knit body 20 is assembled onto the grip portion 1. A lead wire 23 electrically connected to a control device (not illustrated) is connected to each of the anode 20b1 and the cathode 20b2 by knit-crimping or the like. Here, the circumferential direction of the grip portion 1 refers to the direction in which the driver M hangs fingers when gripping the grip portion 1, and the rotational direction refers to the direction in which the grip portion 1 moves when the steering wheel 10 is rotationally steered.

When assembling the knit body 20 onto the grip portion 1, an assembling operator first applies an adhesive to an outer periphery 1b1 of the coating layer 1b. Next, a part of the knit body 20 supporting the carbon nanotubes 22 is hooked to the outer periphery 1b1 of the coating layer 1b. Thereafter, as illustrated in FIG. 7, the operator stretches the knit body 20 by hands to widen the opening 20a, and cover the outer periphery 1b1 of the coating layer 1b with the knit body 20 such that the core material 1a and the coating layer 1b of the grip portion 1 are accommodated within the opening 20a. In this manner, the knit body 20 is assembled onto the grip portion 1.

Here, in the state where the knit body 20 is assembled onto the grip portion 1, the weft direction of the circularly knitted knit body 20 is aligned with the rotational direction of the grip portion 1. In other words, the direction in which the stitches of the weft knitting of the knit body 20 are continued is along the rotational direction of the grip portion 1. Thus, when the knit body 20 is assembled onto the grip portion 1, the knit body 20 is easily stretched, facilitating the assembly of the knit body 20 onto the grip portion 1. Note that the longitudinal direction of the knit body 20 illustrated in FIG. 5 corresponds to the rotational direction of the grip portion 1.

To raise the temperature of the grip portion 1, the driver M first operates a switch (not illustrated) mounted on the vehicle 50. In response to this, the control device controls a power source (not illustrated) mounted on the vehicle 50 to apply a voltage to the electrode portion 20b. This allows a current to flow between the anode 20b1 and the cathode 20b2 of the electrode portion 20b, and the carbon nanotubes 22 are energized to generate heat, raising the temperature of the grip portion 1. In this manner, the hands of the driver M who grips the grip portion 1 are warmed.

As described above, the heating element provided inside the grip portion 1 is configured by the carbon nanotubes 22 supported on the knit body 20, thereby achieving the following effects. That is, the carbon nanotubes 22 are lightweight materials with excellent electrical and thermal conductivity and far-infrared radiation heat effects. Meanwhile, the carbon nanotubes 22 are hard materials. Thus, in the case of using the carbon nanotubes 22 as the heating element, deterioration in the ease of assembly of the heating element onto the grip portion 1 may occur, such as cracking of the carbon nanotubes 22 when assembled onto the grip portion 1 along the curved surface of the grip portion 1.

On the other hand, in the present embodiment, the carbon nanotubes 22 are supported on the knit body 20 having excellent stretchability, and the knit body 20 is then assembled onto the grip portion 1, whereby the carbon nanotubes 22 are assembled onto the grip portion 1. This facilitates the conformity of the carbon nanotubes 22 to the curved surface of the grip portion 1 by utilizing the stretchability of the knit body 20, and facilitates the assembly of the carbon nanotubes 22 onto the grip portion 1. Therefore, according to the steering wheel 10 of the present embodiment, it is possible to suppress deterioration in the ease of assembly of the heating element while using the carbon nanotubes 22 as the heating element. Although the knit body 20 is generally said to be weak in strength, the strength of the knit body 20 is compensated by the carbon nanotubes 22 because the knit body 20 supports the carbon nanotubes 22 having high strength.

The knit body 20 is assembled onto the grip portion 1 by covering the core material 1a of the grip portion 1 such that the core material 1a is accommodated within the opening 20a, in other words, inside the bag of the bag-shaped knit body 20. With such a configuration, the knit body 20 supporting the carbon nanotubes 22 can be easily assembled onto the grip portion 1 at a time. If this is not taken into consideration, the knit body 20 need not be bag-shaped as in the present embodiment, and for example a plurality of knit bodies 20 may be attached to the outer periphery 1b1 of the coating layer 1b with an adhesive or the like and assembled onto the grip portion 1.

The anode 20b1 and the cathode 20b2 of the electrode portion 20b of the knit body 20 are arranged alongside each other in the circumferential direction of the grip portion 1 in the state where the knit body 20 is assembled onto the grip portion 1. With such a configuration, the electrode portion 20b can be disposed throughout the steering wheel 10 in the rotational direction when the steering wheel 10 is viewed from the front. Therefore, the steering wheel 10 can be uniformly warmed, facilitating improvement in thermal efficiency. If this is not taken into consideration, the anode 20b1 and the cathode 20b2 may be arranged alongside each other in the rotational direction of the grip portion 1. Although the stretch can be easily ensured by forming the knit body 20 through circular knitting, the knit body 20 may be formed by other knitting methods.

In the present embodiment, in the state where the knit body 20 is assembled onto the grip portion 1, the weft direction of the circularly knitted knit body 20 is aligned with the rotational direction of the grip portion 1, thereby facilitating the assembly of the knit body 20 onto the grip portion 1. Here, to further improve the ease of assembly of the knit body 20 onto the grip portion 1, the knitting method and the direction of the stitches for the knit body 20 may be partially changed. For example, on the inner periphery 1x of the grip portion 1, assembling the knit body 20 onto the grip portion 1 is easier when the knit body 20 is stretched in the circumferential direction rather than being stretched in the rotational direction of the grip portion 1. Therefore, the weft direction of the portion of the knit body 20 located on the inner periphery 1x of the grip portion 1 may be aligned with the circumferential direction of the grip portion 1. In addition, only a portion of the knit body 20 that requires strength may be woven instead of being knitted.

In the present embodiment, to enhance the stretchability of the knit body 20, the configuration has been described in which chemical fibers such as urethane-based resin or elastomer are used as the fibers 21 forming the knit body 20, and urethane-based resin or elastomer is used for a dispersion liquid in which the carbon nanotubes 22 are dispersed. However, the present invention is not limited thereto, and the knit body 20 may be formed using other types of fibers or dispersion liquid. That is, since a certain degree of stretchability can be obtained by using fibers in a knitted form as a support for the carbon nanotubes 22 regardless of the material and the like of the knit body 20, it is possible to improve the ease of assembly onto the grip portion 1, compared to a configuration in which the carbon nanotubes 22 are simply supported uniformly on a resin sheet and assembled onto the grip portion 1 or a configuration in which the carbon nanotubes are supported on a woven fabric and assembled onto the grip portion 1. However, it is preferable to form the knit body 20 using the fibers 21 or the dispersion liquid having high stretchability as in the present embodiment because the ease of assembly onto the grip portion 1 is further improved.

In the present embodiment, the configuration in which the carbon nanotubes 22 are supported on the knit body 20 formed using fibers different from the carbon nanotubes 22 has been described, but the present invention is not limited thereto. That is, a configuration may be adopted in which the fibrous carbon nanotubes 22 are knitted to form the knit body 20, and the knit body 20 is assembled onto the grip portion 1 as the heating element in the same manner as described above. Even with such a configuration, the carbon nanotubes 22 can be rendered stretchable by being in a knitted form, and therefore, the same effect as described above can be obtained.

In the present embodiment, the configuration has been described in which the carbon nanotubes 22 supported on the knit body 20 is used as the heating element that warms the hands of the driver M who grips the grip portion 1. However, the present invention is not limited thereto, and the carbon nanotubes 22 supported on the knit body 20 may be used as a sensor electrode of a capacitance grip sensor that detects the gripping of the grip portion 1 by the driver M. Even with such a configuration, similarly to the configuration in which the carbon nanotubes 22 are used as the heating element described above, deterioration in the ease of assembly of the sensor electrode onto the grip portion 1 can be suppressed.

In the present embodiment, the configuration in which a conductive yarn is used as the electrode portion 20b for energizing the carbon nanotubes 22 has been described, but the present invention is not limited thereto. That is, the same effect as above can be obtained even if the electrode portion 20b is provided by directly printing a conductive material onto the knit body 20, for example. At this time, the conductive material is preferably a stretchable material.

In the present embodiment, the automobile as the vehicle 50 equipped with the steering wheel 10 has been exemplified, but the present invention is not limited thereto. That is, the vehicle 50 equipped with the steering wheel 10 is not limited to the automobile, as long as the vehicle 50 is an object that carries a human, and may be another vehicle such as a ship or an aircraft.

What is claimed is:

1. A steering device mounted on a vehicle comprising:
a grip portion gripped by a driver during steering;
a heating element that is provided inside the grip portion and generates heat by energization, the heating element including carbon nanotubes supported on a knit formed by knitting fibers; and
an electrode portion configured to energize the heating element.

2. The steering device according to claim 1, wherein
the grip portion includes a core material, and
the knit is formed in a bag shape, and is assembled onto the grip portion by being covered with the core material to accommodate the core material inside the bag.

3. The steering device according to claim 1, wherein the knit is formed by weft knitting, and is disposed such that a weft direction of the weft knitting is aligned with a rotational direction of the grip portion.

4. The steering device according to claim 3, wherein the knit is formed through circular knitting.

5. The steering device according to claim 1, wherein an anode and a cathode of the electrode portion are arranged alongside each other in a circumferential direction of the grip portion.

6. The steering device according to claim 5, wherein the electrode portion is a conductive yarn constituting at least a part of the fibers forming the knit.

7. A steering device mounted on a vehicle comprising:
a grip portion gripped by a driver during steering;
a heating element that is provided inside the grip portion and generates heat by energization, the heating element including a knit formed by knitting fibrous carbon nanotubes; and
an electrode portion configured to energize the heating element.

8. The steering device according to claim 7, wherein
the grip portion includes a core material, and
the knit is formed in a bag shape, and is assembled onto the grip portion by being covered with the core material to accommodate the core material inside the bag.

9. The steering device according to claim 7, wherein the knit is formed by weft knitting, and is disposed such that a weft direction of the weft knitting is aligned with a rotational direction of the grip portion.

10. The steering device according to claim 9, wherein the knit is formed through circular knitting.
